(19) United States
(12) Patent Application Publication
(10) Pub. No.: US 2015/0239278 A1
(43) Pub. Date: Aug. 27, 2015

(54) MARKER SAVER

(71) Applicant: Randy White, Long Beach, CA (US)

(72) Inventor: Randy White, Long Beach, CA (US)

(21) Appl. No.: 14/623,422

(22) Filed: Feb. 16, 2015

Related U.S. Application Data
(60) Provisional application No. 61/942,008, filed on Feb. 19, 2014.

(51) Int. Cl. B43K 23/00; F16M 11/04; B43K 23/08

(52) U.S. Cl. CPC B43K 23/001; B43K 23/08; F16M 11/041

(57) ABSTRACT

A multi compartmental receptacle for releasably and securely holding multiple marker caps holding markers simultaneously and facilitating easy marker management while in use.

### CLAIM OF PRIORITY

This patent application claims priority under 35 USC 119 (e) (1) from U.S. Provisional Patent Application Ser. No. 61/942,008 filed Feb. 19, 2014, of common inventorship herewith entitled, “marker Saver,” which is incorporated herein by reference as though the same were set forth in its entirety.

### FIELD OF THE INVENTION

The present invention pertains to the field of writing utensils, and more specifically to the field of marker pen holders.

### BACKGROUND OF THE INVENTION

The prior art has put forth several designs for marker pen holders. Among these are:

U.S. Pat. No. 7,740,133 to Daniel Lamas describes a caddy for holding at least one marker therein. The caddy comprises a body that has at least one elongated channel therein. Each channel is adapted to receive one of the markers slidably therein. Each channel terminates at a distal end in a fitted cap portion for hermetically receiving a marking end of one of the markers. The body is comprised of a plastic top shell and a plastic bottom shell each affixed together at a seam along peripheral edges thereof. The body further includes side edges having an ergonomic grip and a substantially flat bottom side for affixing thereto a removable eraser pad. A battery operated laser pointer device is included within the body. An actuator activates the laser pointer device to produce a laser beam that projects through a laser beam aperture of the body.

U.S. Pat. No. 7,419,320 to Claude LaBrasca describes a marker pen storage system comprising a housing having a plurality of receptacles for receiving marker pens. Each receptacle is formed to include an upper and lower cavity, the upper cavity located at the opening of the receptacle and formed to include a first upper inclined section and a first lower inclined section. The first upper inclined section has a greater incline than the first lower inclined section. Said lower cavity is sized to receive a writing end of a marker pen. Receptacle openings are formed immediately adjacent to create guidance walls between each receptacle. These openings prevent a flat upper surface from being formed between adjacent receptacles and a snap ring formed between the upper and lower cavities. A relatively airtight seal is formed around the writing end of a marking pen when it is completely inserted into the lower cavity so as to prevent circulation of air to the writing end of an inserted marking pen. The snap ring produces a snap feel and sound when a marker pen is completely inserted into the lower cavity. Guidance walls between the receptacles enable a user to properly insert a marker pen without having a direct line of site to the proper receptacle, making the marker pen holder very easy for young children to use and put away the marker when it is time to clean up. The snap ring prevents markers from spilling out of the holder which is very useful when marker pens are carried in children's backpacks to and from school or the like.

U.S. Pat. No. 6,257,539 to Pedro R. Pelaez describes a holder for marker pens that keep the latter readily available for use while providing a relatively sealed compartment that prevents or minimizes the circulation of air around the tip of the pen. The housing has slanted walls that provide structural stability to the holder when it holds one or more pens. An opening in the housing includes upper and lower cavities with a slanted portion in between that acts as a seal for the end of the tubular housing of a pen. A step in the lower cavity further reduces its diameter ensuring the further isolation of the pen's tip thus protecting from the frying action of circulating air. Portable embodiments for use with a user's belt permit ready access to pens for an ambulatory user. One of these embodiments includes a removable pen holder member.

None of these prior art references describe the present invention.

### SUMMARY OF THE INVENTION

It is an object of the present invention to provide a multi compartmental receptacle for holding several marker pens simultaneously.

### BRIEF DESCRIPTION OF THE DRAWINGS

FIG. 1 is a prototypical diagonal front view showing a weighted sturdy base containing multiple individual openings and locking buttons with each opening holding a marker pen.

FIG. 2 is an instructional prototypical close up view showing a locking button that is pressed to lock a marker's cap into the opening in which it is inserted.

FIG. 3 is a functional prototypical close up view showing how a marker is insertable into a lockable receiving cap.

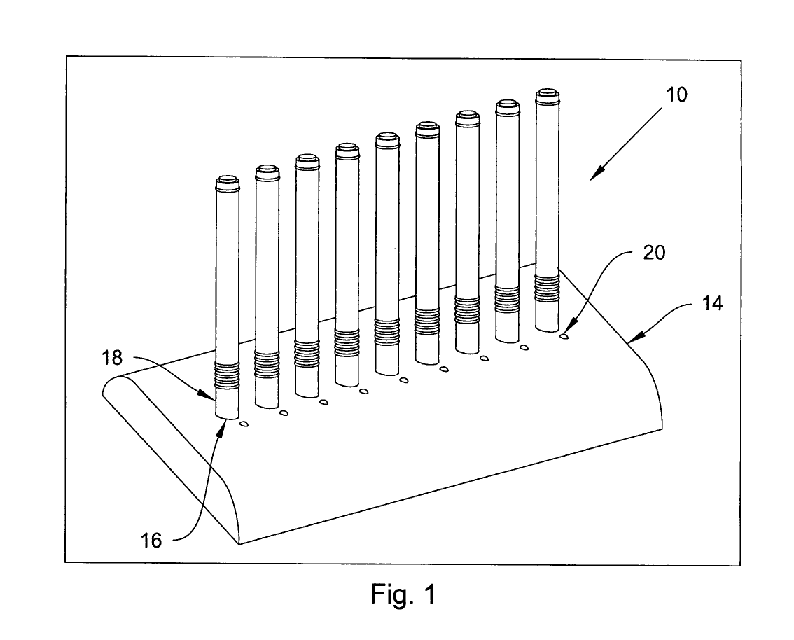

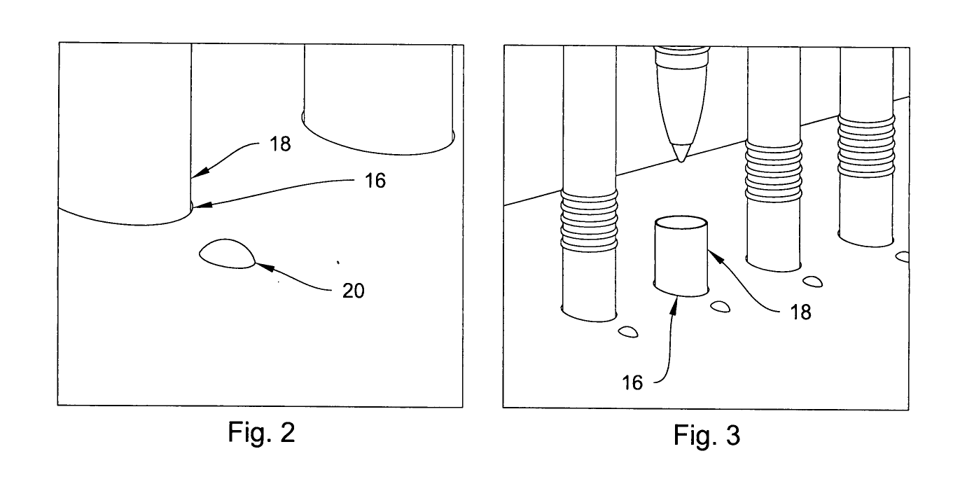

### DETAILED DESCRIPTION OF THE INVENTION

The history of writing instruments by which humans have recorded and conveyed thoughts, feelings, and grocery lists is the history of civilization itself. This is how we know the story of us, by the drawings, signs, and words we have recorded. From charcoal used to scratch messages on rocks to ubiquitous ballpoints now used in homes, offices, and schools worldwide, permanent marking pens of one type or another have been used for thousands of years. A common implement used for marking or writing is simply named marker. Fat, round, felt tipped pens, markers are versatile coloring instruments that allow many creative possibilities. They have enjoyed continued popularity since the middle of the twentieth century because of their brilliance, consistent high quality, economic value, ease of use and availability. Along with crayons, magic markers are typically the first drawing instruments tried by children. These multifaceted instruments, used in conjunction with dry erase boards, are invaluable tools in classrooms and boardrooms, allowing instructors and presenters to convey a plethora of important information in a manner that is easily seen by students and business associates.

While the colored marker is a tool that is appreciated by adults and children alike, it presents quite a challenge to users. When it is necessary to employ several markers when making presentations or creating works of art, marker management can become an issue. Standing in front of a dry erase board, one holds the marker in use in one hand and juggles the other markers in the opposite hand. This endeavor is fraught with frustration as one tries to cap each marker between uses, change hands, and keep from marking the skin or clothing, all the while trying to convey information in a professional manner. Placing a series of colored markers on a table while working on an artistic creation may find the user constantly bending to pick up markers that have rolled off the surface to the floor. It is frustrating and time consuming to constantly uncap and recap each marker while working on a project. The user may leave the cap off, but doing so may result in the marker drying out.

Please refer to the figures. The present invention, hereinafter referred to as the Marker Saver, is a multi compartmental receptacle 10 for holding several markers simultaneously and facilitating easy marker management while in use. Fabricated of a durable plastic, wood, or aluminum or a combination of plastic, wood and aluminum, the present invention is rectangular in shape and compact in size. With a weighted base 14 to keep it securely in place, the Marker Saver measures approximately seven inches in length and one and on half inches in width. The top portion of the Marker Saver contains a series of at least four circular receptacles 16, sized accordingly to accommodate marker caps. Each receptacle 16 is configured to lock in the marker's cap 18. Positioned directly in front of each receptacle 16, a push button mechanism 20 snaps on the cap as well as releases the cap when needed. When depressed, push button 20 activates a lever, not shown, which abuts against the outer perimeter of the cap thereby securing the cap 18 into the receptacle 16. The attractive and functional Marker Saver is manufactured in a variety of eye catching colors to appeal to individual tastes.

Use and application of the Marker Saver is simple and straightforward. First, the user assembles a collection of markers. One may choose markers colored green, red, black, and yellow. The user then inserts each capped marker, tip end first, into a corresponding receptacle 16 on the Marker Saver. The provided push button 20 is pressed to lock the cap 18 and marker in place. When making a presentation, the user holds the Marker Saver in one hand and removes the chosen marker so it disengages from the cap 18, which remains locked in the Marker Saver 10. In this manner, the user retrieves and replaces each marker as needed with the Marker Saver securely keeping each marker and cap conveniently within reach. When working on a surface such as a desk, the Marker Saver is placed flat on the desk and its weighted base keeps the present invention from sliding.

The Marker Saver provides a simple and effective means of managing and using a collection of different markers. A handy device specially designed to hold at least four markers at one time, this practical holder eliminates the need to wrestle with multiple instruments when it is necessary to use more than one at a time. Teachers and business people will present a more professional and relaxed demeanor as they convey the day's history lesson or outline project ideas. Keeping markers secure within the confines of the present invention between uses alleviates the risk of dropping all markers on the floor, while also preventing users from accidentally marring clothes or surfaces with indelible marker ink. Cleverly locking the caps into place, the Marker Saver provides expedience and ease in protecting tips from air exposure between uses. Simple in construction yet effective in application, the Marker Saver is filled and put to use in a matter of seconds. Fabricated of durable, high quality materials, the Marker Saver will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A multi compartmental receptacle device for holding multiple marker pens simultaneously, comprising:
an essentially rectangular device having a weighted base and a top portion, wherein the top portion contains a series of circular receptacles, wherein the circular receptacle is sized accordingly to accommodate a marker cap, wherein the marker cap is circular and fits into the receptacle, and further wherein the circular marker cap has an outer perimeter.

2. The multi compartmental receptacle device of claim 1 wherein the top portion further comprises a push button associated with each circular receptacle, wherein the push button is located directly in front of the associated receptacle, and wherein the push button activates a lever which lever abuts against the outer perimeter of a marker cap thereby securing the cap into the receptacle.

3. The multi compartmental receptacle device of claim 1, wherein the device is made of plastic, wood, aluminum, or a combination of plastic, wood and aluminum.

4. The multi compartmental receptacle device of claim 2, wherein the device is made of plastic, wood, aluminum, or a combination of plastic, wood and aluminum.

5. The multi compartmental receptacle device of claim 1, manufactured in a variety of eye catching colors to appeal to individual tastes.

6. The multi compartmental receptacle device of claim 2, manufactured in a variety of eye catching colors to appeal to individual tastes.

7. The multi compartmental receptacle device of claim 1, which device measures approximately seven inches in length and one and on half inches in width.

8. The multi compartmental receptacle device of claim 2, which device measures approximately seven inches in length and one and on half inches in width.

9. The multi compartmental receptacle device of claim 1, wherein the number of receptacles is more than one.

10. The multi compartmental receptacle device of claim 2, wherein the number of receptacles is more than one.

11. The multi compartmental receptacle device of claim 1, wherein the number of receptacles is four to twelve.

12. The multi compartmental receptacle device of claim 2, wherein the number of receptacles is four to twelve.
